(19) United States
(12) Patent Application Publication
(10) Pub. No.: US 2018/0214902 A1
(43) Pub. Date: Aug. 2, 2018

(54) WATERFALL SYSTEM

(71) Applicant: Renzo Focaccia, Toronto (CA)

(72) Inventor: Renzo Focaccia, Toronto (CA)

(21) Appl. No.: 15/423,218

(22) Filed: Feb. 2, 2017

(51) Int. Cl. B05B 17/08; B05B 1/20

(52) U.S. Cl. CPC B05B 17/085; F21V 23/001; B05B 1/20

(57) ABSTRACT

A waterfall system includes a container assembly configured to receive water. A frame assembly is configured to be fixedly mounted to the container assembly. The frame assembly is also configured to accommodate a tube assembly. The tube assembly is configured to extend from the container assembly, along the frame assembly. The tube assembly is also configured to be fluidly connected to a pump assembly. Spaced-apart water-flow guides are configured to extend from a tube portion of the tube assembly toward the water positioned in the container assembly. This is done in such a way that the spaced-apart water-flow guides, in use, respectively guide spaced-apart linear flows of water from the tube portion into the container assembly.

### TECHNICAL FIELD

This document relates to the technical field of (and is not limited to) a waterfall system (and method therefor).

### BACKGROUND

An artificial waterfall is a water feature or fountain that imitates, in some aspect, a waterfall.

### SUMMARY

It will be appreciated that there exists a need to mitigate (at least in part) at least one problem associated with the existing waterfall systems (also called the existing technology). After much study of the known systems and methods with experimentation, an understanding of the problem and its solution has been identified and is articulated as follows:

Artificial waterfalls serve to highlight the surroundings (a view, a scene, a scenery, etc.) or to provide focus for a particular aspect of a surrounding (either interior or exterior), such as in an outdoor garden, backyard, or indoors. The ancient Romans made artificial waterfalls.

For instance, at least one problem associated with existing artificial waterfalls is that water becomes inadvertently splashed onto the ground, and then water needs to be added to the artificial waterfall (to replenish the water). Other problems also exist, which are described below.

To mitigate, at least in part, at least one problem associated with the existing technology, there is provided (in accordance with a major aspect) an apparatus. The apparatus includes a waterfall system 100. The waterfall system 100 is configured to minimize the splash of water as a flow of water reaches a container assembly 102. The waterfall system 100, in use, reduces the need to refill the container assembly 102 with additional fresh water since water splash is minimized. More specifically, the waterfall system 100 includes a container assembly 102 configured to be positioned on a working surface 900. The container assembly 102 is also configured to receive and support water therein once the container assembly 102 is positioned on the working surface 900. A frame assembly 104 is configured to be fixedly mounted to, and extend vertically upward from, the container assembly 102. The frame assembly 104 has a vertical height extending, at least in part, from a lower frame section 106 of the frame assembly 104 to an upper frame section 108 of the frame assembly 104 (once the frame assembly 104 is fixedly mounted to, and extends vertically upward from, the container assembly 102). The frame assembly 104 is also configured to accommodate a tube assembly 110. The tube assembly 110 is configured to extend from the interior of the container assembly 102, along, at least in part, the vertical height of the frame assembly 104 from the lower frame section 106 toward the upper frame section 108 of the frame assembly 104 (once the frame assembly 104 is fixedly mounted to, and extends vertically upward from, the container assembly 102). The tube assembly 110 is also configured to be fluidly connected to a pump assembly 112. The pump assembly 112 is configured to pump water along the tube assembly 110 (once the pump assembly 112 is fluidly connected to the tube assembly 110). Spaced-apart water-flow guides 114 are configured to respectively extend from a tube portion 111 of the tube assembly 110 (in which the tube portion 111 is configured to be mounted to the upper frame section 108 of the frame assembly 104) toward the water positioned in the container assembly 102. This is done in such a way that the spaced-apart water-flow guides 114, in use, respectively guide spaced-apart linear flows of water from the tube portion 111 positioned at the upper frame section 108 of the frame assembly 104 into the container assembly 102 (once the pump assembly 112, in use, pumps the water along the tube assembly 110).

To mitigate, at least in part, at least one problem associated with the existing technology, there is provided (in accordance with a major aspect) an apparatus. The apparatus includes a waterfall system 100. The waterfall system 100 includes a container assembly 102 configured to receive and support water. Spaced-apart elongated columns 202 are configured to be mounted to, and extend vertically upward from, the container assembly 102. A spanning assembly 204 is configured to be fixedly attached to, and to extend between, the spaced-apart elongated columns 202. The spanning assembly 204 is also configured to be fixedly positioned vertically above the container assembly 102 (once the spanning assembly 204 is fixedly attached to, and extended between, the spaced-apart elongated columns 202). A tube assembly 110 is configured to extend from the interior of the container assembly 102 to the spanning assembly 204. A pump assembly 112 is configured to be fluidly connected to the tube assembly 110. The pump assembly 112 is also configured to pump water along the tube assembly 110 (once the pump assembly 112 is fluidly connected to the tube assembly 110). Spaced-apart water-flow guides 114 are configured to respectively extend from a tube portion 111 of the tube assembly 110 (in which the tube portion 111 is mounted to the spanning assembly 204) toward the water positioned in the container assembly 102. This is done in such a way that the spaced-apart water-flow guides 114, in use, respectively guide spaced-apart linear flows of water from the tube portion 111 (in which the tube portion 111 is positioned at the spanning assembly 204) and into the container assembly 102 (once the pump assembly 112, in use, pumps the water along the tube assembly 110).

To mitigate, at least in part, at least one problem associated with the existing technology, there is provided (in accordance with a major aspect) a method. The method is for operating a waterfall system 100. The method includes positioning a container assembly 102 on a working surface 900, in which the container assembly 102 is configured to receive and support water therein once the container assembly 102 is positioned on the working surface 900. The method includes also includes fixedly mounting a frame assembly 104 to, and extending the frame assembly 104 vertically upward from, the container assembly 102. The frame assembly 104 has a vertical height extending, at least in part, from a lower frame section 106 of the frame assembly 104 to an upper frame section 108 of the frame assembly 104 (once the frame assembly 104 is fixedly mounted to, and extends vertically upward from, the container assembly 102). The frame assembly 104 is also configured to accommodate a tube assembly 110. The tube assembly 110 is configured to extend from the interior of the container assembly 102, along, at least in part, the vertical height of the frame assembly 104 from the lower frame section 106 toward the upper frame section 108 of the frame assembly 104 once the frame assembly 104 is fixedly mounted to, and is extended vertically upward from, the container assembly 102. The tube assembly 110 is also configured to be fluidly connected to a pump assembly 112. The pump assembly 112 is configured to pump water along the tube assembly 110 once the pump assembly 112 is fluidly connected to the tube assembly 110. The method also includes respectively extending spaced-apart water-flow guides 114 from a tube portion 111 of the tube assembly 110, in which the tube portion 111 is mounted to the upper frame section 108 of the frame assembly 104, toward the water positioned in the container assembly 102. This is done in such a way that the spaced-apart water-flow guides 114, in use, respectively guide spaced-apart linear flows of water from the tube portion 111, which is positioned at the upper frame section 108 of the frame assembly 104, into the container assembly 102 (once the pump assembly 112, in use, pumps the water along the tube assembly 110).

Other aspects are identified in the claims. Other aspects and features of the non-limiting embodiments may now become apparent to those skilled in the art upon review of the following detailed description of the non-limiting embodiments with the accompanying drawings. This Summary is provided to introduce concepts in simplified form that are further described below in the Detailed Description. This Summary is not intended to identify key features or essential features of the disclosed subject matter, and is not intended to describe each disclosed embodiment or every implementation of the disclosed subject matter. Many other novel advantages, features, and relationships will become apparent as this description proceeds. The figures and the description that follow more particularly exemplify illustrative embodiments.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 depicts a perspective view of an embodiment of a waterfall system 100;

FIG. 2 depicts a front view of an embodiment of the waterfall system 100 of FIG. 1;

FIG. 3 and FIG. 4 depict a front view (FIG. 3) and an end view (FIG. 4) of embodiments of the waterfall system 100 of FIG. 1;

FIG. 5 depicts a front view of an embodiment of the waterfall system 100 of FIG. 1;

FIG. 6 depicts a front view of an embodiment of the waterfall system 100 of FIG. 1;

FIG. 7A depicts a front view of an embodiment of the waterfall system 100 of FIG. 1;

FIG. 7B depicts a front view of an embodiment of the waterfall system 100 of FIG. 1;

FIG. 8 depicts a front view of an embodiment of the waterfall system 100 of FIG. 1;

FIG. 9 and FIG. 10 depict a front view (FIG. 9) and a bottom view (FIG. 10) of embodiments of the waterfall system 100 of FIG. 1;

FIG. 11 and FIG. 12 depict a front view (FIG. 11) and a side view (FIG. 12) of embodiments of the waterfall system 100 of FIG. 1;

FIG. 13, FIG. 14 and FIG. 15 depict a front view (FIG. 13), an end view (FIG. 14), and a top view (FIG. 15) of embodiments of the waterfall system 100 of FIG. 1; and

FIG. 16, FIG. 17 and FIG. 18 depict a side view (FIG. 16), an end view (FIG. 17), and a front view (FIG. 18) of embodiments of the waterfall system 100 of FIG. 1.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted. Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

100 waterfall system
102 container assembly
103 container cavity
104 frame assembly
105 footing assembly
106 lower frame section
108 upper frame section
110 tube assembly
111 tube portion
112 pump assembly
113 weight assembly
114 spaced-apart water-flow guides
115 light-source assembly
116 entrance portal
117 power plug
118 spaced-apart exit portals
121 downwardly pointing arrows
202 spaced-apart elongated columns
204 spanning assembly
206 cover assembly
302 detachable columns
304 hinge assembly
306 connector
308 tendon assembly
310 pin assembly
312 pin receiver
314 drain assembly
316 connector
318 solar panel
320 handle
322 connector
900 working surface

### DETAILED DESCRIPTION OF THE EXEMPLARY EMBODIMENTS

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of may be defined by the claims (in which the claims may be amended during patent examination after filing of this application). For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described.

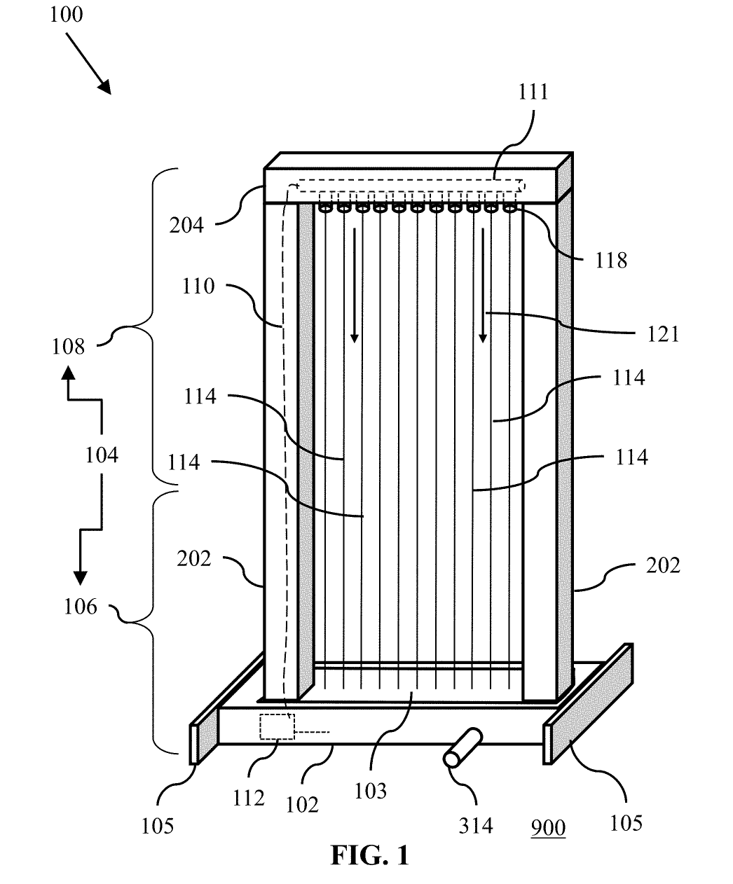

FIG. 1 depicts a perspective view of an embodiment of a waterfall system 100.

Referring to the embodiment as depicted in FIG. 1, the apparatus includes (and is not limited to) a waterfall system 100, which may be called an artificial waterfall.

In accordance with a major aspect, the waterfall system 100 includes (and is not limited to) a synergistic combination of (comprising) a container assembly 102, a frame assembly 104, and spaced-apart water-flow guides 114.

The container assembly 102 may be called a bucket, a water reservoir, a fluid reservoir, etc., and any equivalent thereof. The container assembly 102 is configured to be positioned on a working surface 900. The container assembly 102 is also configured to receive and support water therein once the container assembly 102 is positioned on the working surface 900.

The container assembly 102 may be elongated, rectangular-shaped, square-shaped, circular-shaped, oblong-shaped, etc., and any equivalent thereof. The container assembly 102 may be made of any suitable material (for indoor usage and/or outdoor usage), such as wood, plastic (with an ultraviolet protectant), metal, concrete, etc., and any equivalent thereof. The interior of the container assembly 102 may have a waterproof liner that is inserted therein (in which the waterproof liner is made of a plastic material). The waterproof liner may be removable from the interior of the container assembly 102, or the waterproof liner may be permanently installed to the interior of the container assembly 102. For instance, a waterproof material (rubber or paint) may be applied to the interior of the container assembly 102, if desired. Preferably and more specifically, the container assembly 102 defines a container cavity 103. Preferably, the container assembly 102 includes a footing assembly 105 (also called a stabilizer assembly or stabilizer bar, etc.). The footing assembly 105 is positioned at opposite end portions of the container assembly 102, and extends past the outer peripheral edge of the container assembly 102. The components of the container assembly 102 may be connected together (or may be connected with other non-container components), either directly or indirectly, with any suitable connector, such as nails, screws, threaded bolts (with spacers), glue, etc., and any equivalent thereof.

The frame assembly 104 is configured to be fixedly mounted to, and extend vertically upward from, the container assembly 102. The frame assembly 104 has a vertical height extending, at least in part, from a lower frame section 106 of the frame assembly 104 to an upper frame section 108 of the frame assembly 104 (once the frame assembly 104 is fixedly mounted to, and extends vertically upward from, the container assembly 102).

The frame assembly 104 may be elongated, rectangular-shaped, square-shaped, provide a single vertically-extending column or multiple vertically-extending columns, etc., and any equivalent thereof. The container assembly 102 may be made of any suitable material (for indoor usage and/or outdoor usage), such as wood, plastic (with an ultraviolet protectant), metal, concrete, etc., and any equivalent thereof. The components of the frame assembly 104 may be connected together (or may be connected with other non-frame components, such as the container assembly 102), either directly or indirectly, with any suitable connector, such as nails, screws, threaded bolts (with spacers), glue, etc., and any equivalent thereof.

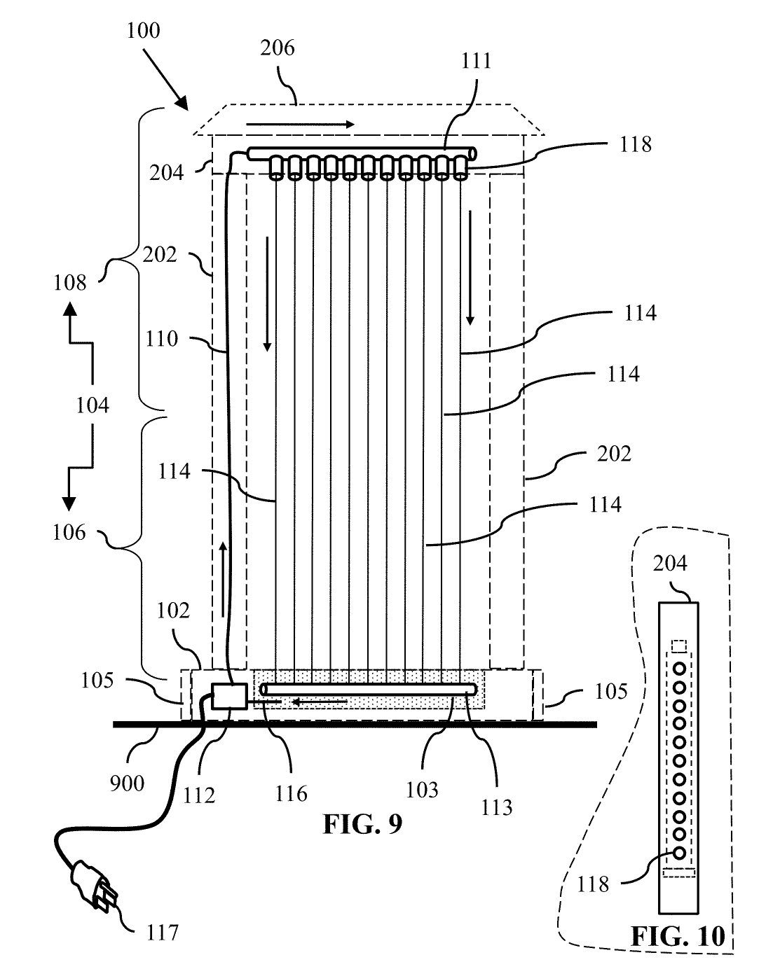

The frame assembly 104 is also configured to accommodate a tube assembly 110 (also called a hose, conduit, etc.). An embodiment of the tube assembly 110 is also clearly depicted in FIG. 9. The tube assembly 110 is configured to extend from the interior of the container assembly 102, along (at least in part) the vertical height of the frame assembly 104 from the lower frame section 106 toward the upper frame section 108 of the frame assembly 104 (once the frame assembly 104 is fixedly mounted to, and extends vertically upward from, the container assembly 102). The tube assembly 110 is also configured to be fluidly connected (either directly or indirectly) to a pump assembly 112. An embodiment of the pump assembly 112 is also clearly depicted in FIG. 9. The pump assembly 112 is configured to pump water along the tube assembly 110 once the pump assembly 112 is fluidly connected to the tube assembly 110 (and the pump assembly 112 is appropriately powered).

The tube assembly 110 (and any part thereof) may include any suitable material (in any suitable combination), such as a rubber tube, a plastic tube (with an ultraviolet protectant, etc.), a metal tube, and any equivalent thereof. The tube assembly 110 may be securely connected (either directly or indirectly) to the frame assembly 104 using any suitable connector, such as U-shaped or C-shaped connectors, etc., and any equivalent thereof.

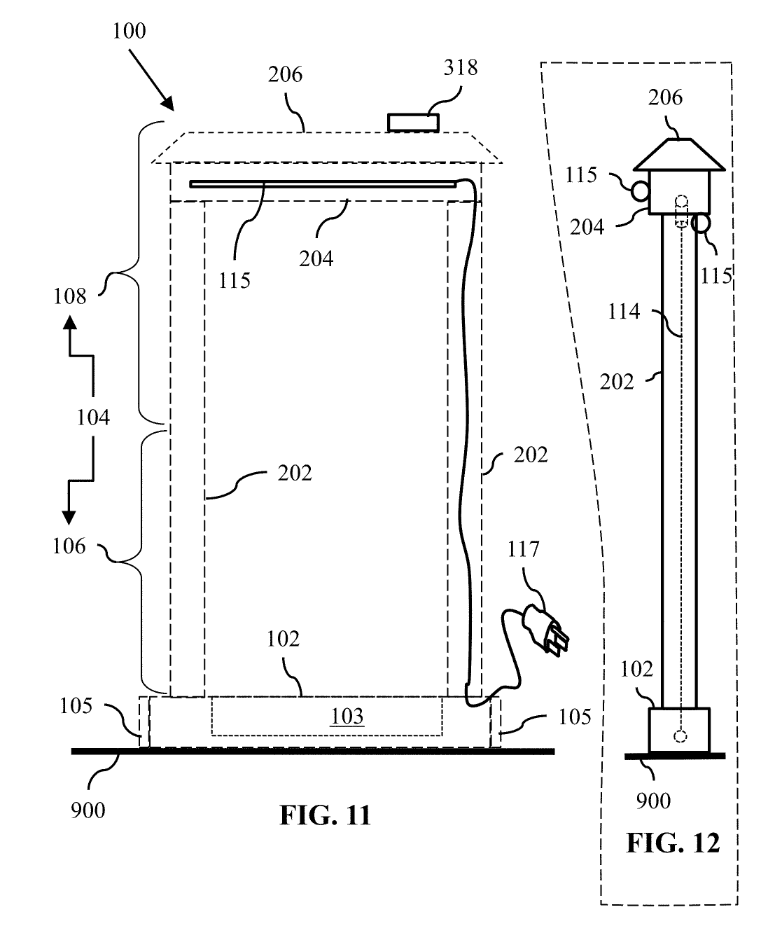

Preferably, the pump assembly 112 is configured to be submersible (at least in part) in water. The pump assembly 112 may include any suitable pump, such as a gardening pump deployable in a garden pond, etc., and any equivalent thereof. The pump assembly 112 may be configured to be powered by a power cord with a mains receptacle outlet, such as 120 Volts AC (Alternating Current), having a suitable electrical grounding connection (for safety reasons). Alternatively, the pump assembly 112 may be solar powered (such as with a solar panel 318 as depicted in FIG. 11) with a back-up battery assembly (if desired).

The spaced-apart water-flow guides 114 are configured to respectively extend from a tube portion 111 (also called a pipe) of the tube assembly 110 toward the water positioned in the container assembly 102. This is done in such a way that the spaced-apart water-flow guides 114, in use, respectively guide spaced-apart linear flows of water from the tube portion 111 positioned at the upper frame section 108 of the frame assembly 104 into the container assembly 102 (once the pump assembly 112, in use, pumps the water along the tube assembly 110). Preferably, the tube portion 111 is mounted to the upper frame section 108 of the frame assembly 104. An embodiment of the tube portion 111 is also clearly depicted in FIG. 9. The flow of falling water (along each instance of the spaced-apart water-flow guides 114) is indicated with downwardly pointing arrows 121.

Advantageously, the spaced-apart water-flow guides 114, in use, minimize the splash of water as the spaced-apart linear flows of water (which are guided along the spaced-apart water-flow guides 114 and which exit from the upper frame section 108 of the frame assembly 104) reach the water contained in the container assembly 102. The spaced-apart water-flow guides 114, in use, reduce the need to refill the container assembly 102 with additional fresh water since water splash is minimized.

Preferably, the spaced-apart water-flow guides 114 are further configured to provide a spacing of air between the spaced-apart water-flow guides 114 once the water is made to run along the spaced-apart water-flow guides 114 toward the container assembly 102. This is done in such a way that the spaced-apart water-flow guides 114, in use, permit a partially obstructed view of the scenery that is located or positioned behind the spaced-apart water-flow guides 114. Advantageously, this feature enhances the aesthetic appeal of the garden or other scenery that is located behind the waterfall system 100.

Referring to the embodiment as depicted in FIG. 1, the spaced-apart water-flow guides 114 are elongated and linear. More specifically, the spaced-apart water-flow guides 114 include a set of guide wires. The spaced-apart water-flow guides 114 may be made of a plastic material, such as fishing line, etc., and any equivalent thereof. The spaced-apart water-flow guides 114 may form any suitable shape, such as a curved line or curved geometrical pattern if so desired, and any equivalent thereof.

Referring to the embodiment as depicted in FIG. 1, the frame assembly 104 includes spaced-apart elongated columns 202. The spaced-apart elongated columns 202 are configured to be fixedly mounted to, and to extend vertically upward from, the container assembly 102. This is done in such a way that once the spaced-apart elongated columns 202 are fixedly mounted to the container assembly 102, the spaced-apart elongated columns 202 extend vertically upward from the container assembly 102. Preferably, the spaced-apart elongated columns 202 are attached to the opposite end portions (and any equivalent thereof) of the container assembly 102. For instance, the spaced-apart elongated columns 202 are configured to be fixedly mounted to the sidewalls (and any equivalent thereof) of the container assembly 102. The spaced-apart elongated columns 202 may be made of any suitable material having an appropriate strength component, etc.

Referring to the embodiment as depicted in FIG. 1, the frame assembly 104 further includes a spanning assembly 204 (also called a header assembly). The spanning assembly 204 is configured to be (A) fixedly attached to, and to extend between, the spaced-apart elongated columns 202, and (B) fixedly positioned vertically above the container assembly 102. The spanning assembly 204 may be made of any suitable material having an appropriate strength component, etc.

In accordance with an embodiment, the bottom section of the container assembly 102 includes a drain assembly 314 configured to receive a mating plug for drainage of the container cavity 103.

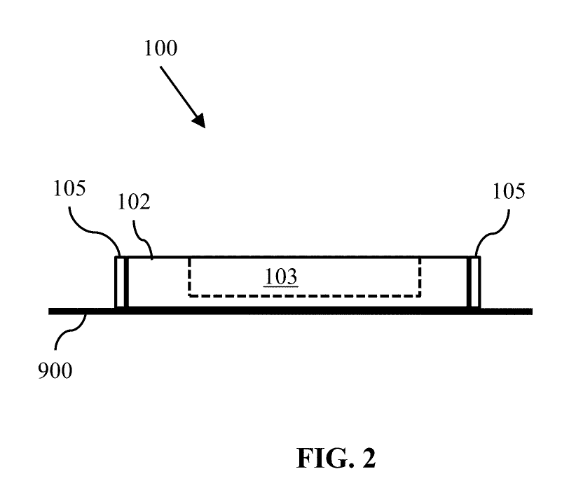

FIG. 2 depicts a front view of an embodiment of the waterfall system 100 of FIG. 1.

Referring to the embodiment as depicted in FIG. 2, the container assembly 102 is fixedly attached to the footing 105, and is then placed on the working surface 900. The container cavity 103 is open to the top section of the container assembly 102.

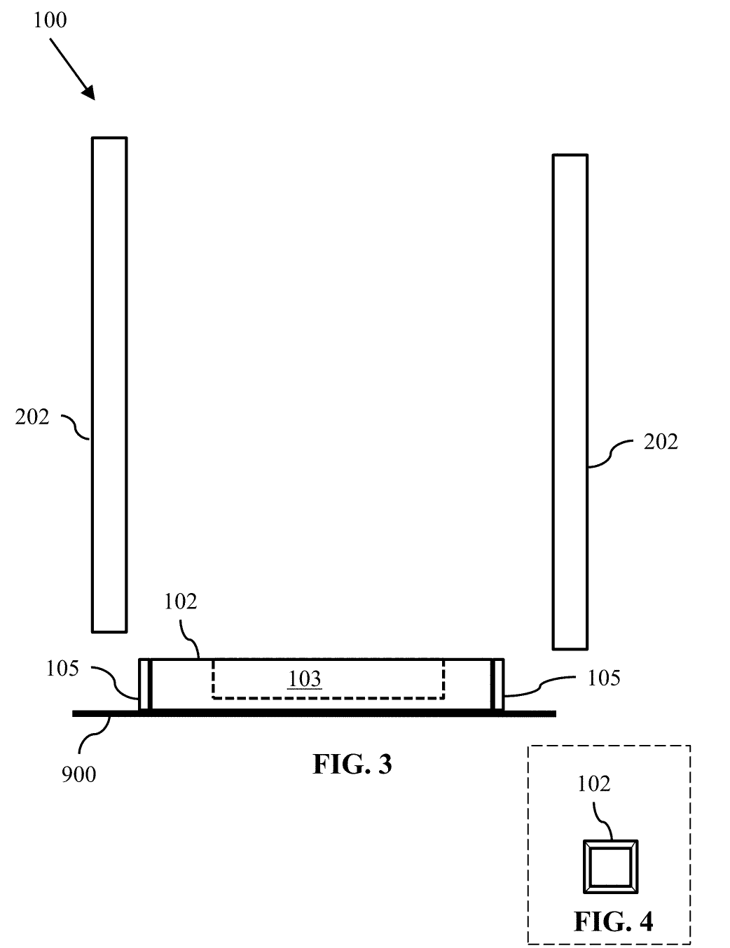

FIG. 3 and FIG. 4 depict a front view (FIG. 3) and an end view (FIG. 4) of embodiments of the waterfall system 100 of FIG. 1.

Referring to the embodiment as depicted in FIG. 3, the spaced-apart elongated columns 202 are positioned at opposite sides (opposite end portions) of the container assembly 102.

Referring to the embodiment as depicted in FIG. 4, a least one of the spaced-apart elongated columns 202 has a square-shaped cross-sectional profile. The square-shaped cross-sectional profile is made with mitered corners, which gives the impression to the casual observer that the spaced-apart elongated columns 202 are made of a solid material (such as a solid column or beam of wood). Preferably, the spaced-apart elongated columns 202 are made of wood, or a plastic material having a UV (ultraviolet) protectant, etc.

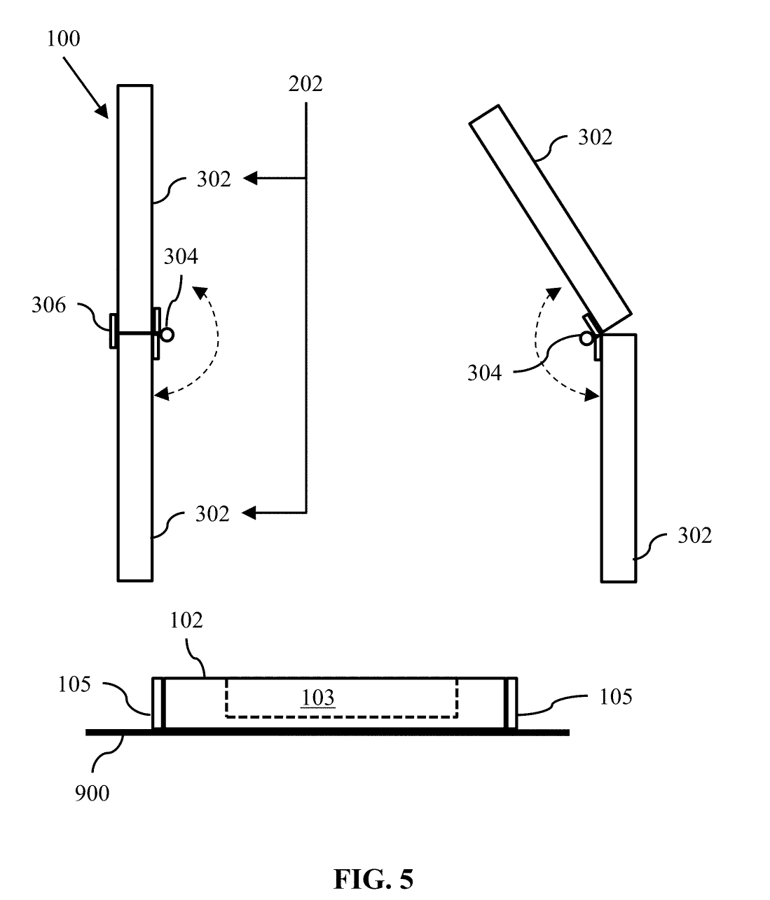

FIG. 5 depicts a front view of an embodiment of the waterfall system 100 of FIG. 1.

Referring to the embodiment as depicted in FIG. 5, each of the spaced-apart elongated columns 202 is configured to be formed from detachable columns 302. The detachable columns 302 may be called foldable columns, etc. The detachable columns 302 may be called collapsible columns, etc. The detachable columns 302 may be positioned in an end-to-end relationship. The compact size (such as the vertical height) of the detachable columns 302 (relative to the spaced-apart elongated columns 202) facilitates (provides) convenient relocation and transport of the waterfall system 100. Preferably, the detachable columns 302 are configured to be fixedly connected (either directly or indirectly) with each other in such a way that the detachable columns 302 form the spaced-apart elongated columns 202 once the detachable columns 302 are fixedly connected with each other (preferably in an end-to-end relationship). Preferably, the detachable columns 302 are configured to be fixedly connected (either directly or indirectly) with each other in an end-to-end relationship.

Referring to the embodiment as depicted in FIG. 5, the detachable columns 302 are connected (either directly or indirectly) to each other with a hinge assembly 304 in such a way that the detachable columns 302 are pivotally movable relative to each other between an extended position (as depicted on the left side of FIG. 5) and a collapsed position (as partially depicted on the right side of FIG. 5). In the extended position, a connector 306 is configured to securely connect (either directly or indirectly) the detachable columns 302 with each other in the end-to-end relationship.

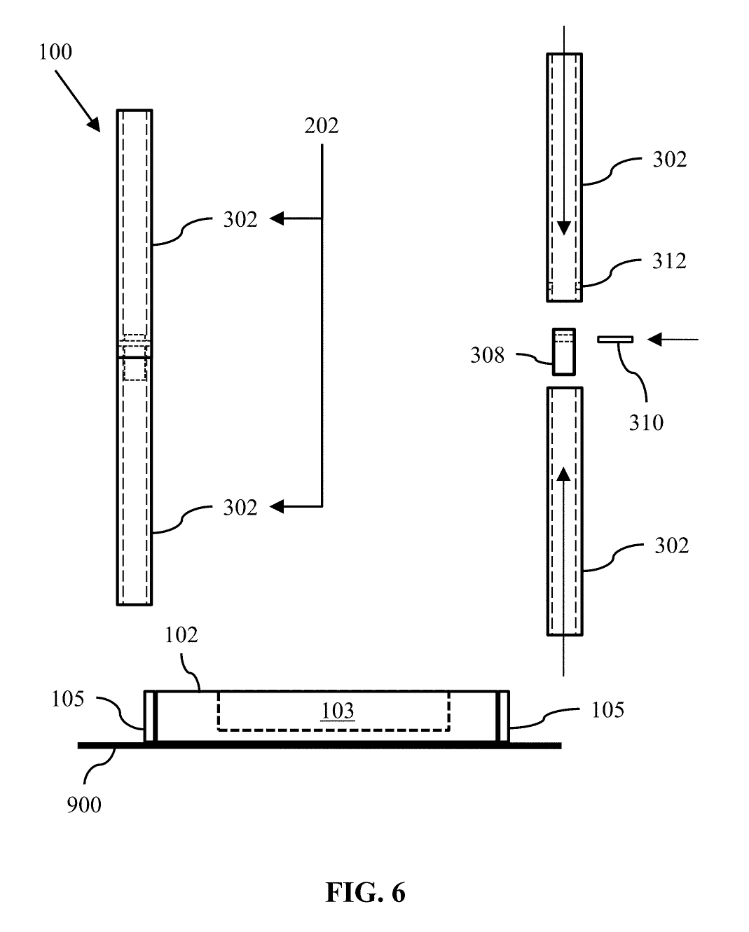

FIG. 6 depicts a front view of an embodiment of the waterfall system 100 of FIG. 1.

Referring to the embodiment as depicted in FIG. 6, the detachable columns 302 are connected (either directly or indirectly) to each other with a tendon assembly 308. The tendon assembly 308 is slideably received into the hollow end sections of the detachable columns 302. A pin receiver 312 is defined by the hollow end sections of the detachable columns 302. The pin receiver 312 is configured receive a pin assembly 310. The pin assembly 310 is configured to fixedly connect (either directly or indirectly) the detachable columns 302 with the tendon assembly 308 (once the tendon assembly 308 is slideably received into the hollow end sections of the detachable columns 302). The right side of FIG. 6 depicts a collapsed position of the detachable columns 302. The left side of FIG. 6 depicts an extended position of the detachable columns 302.

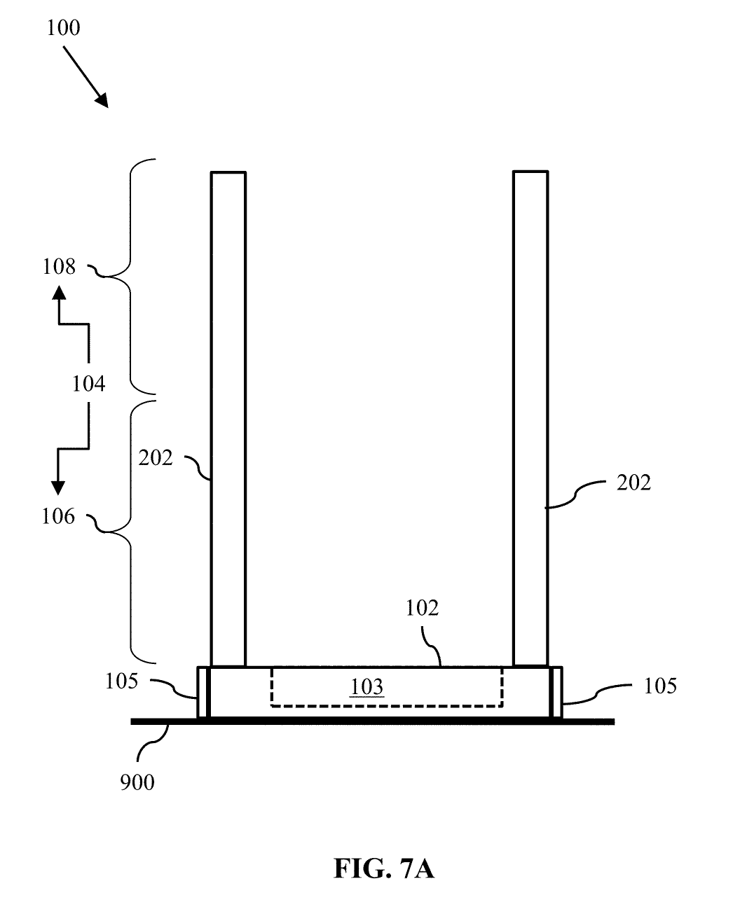

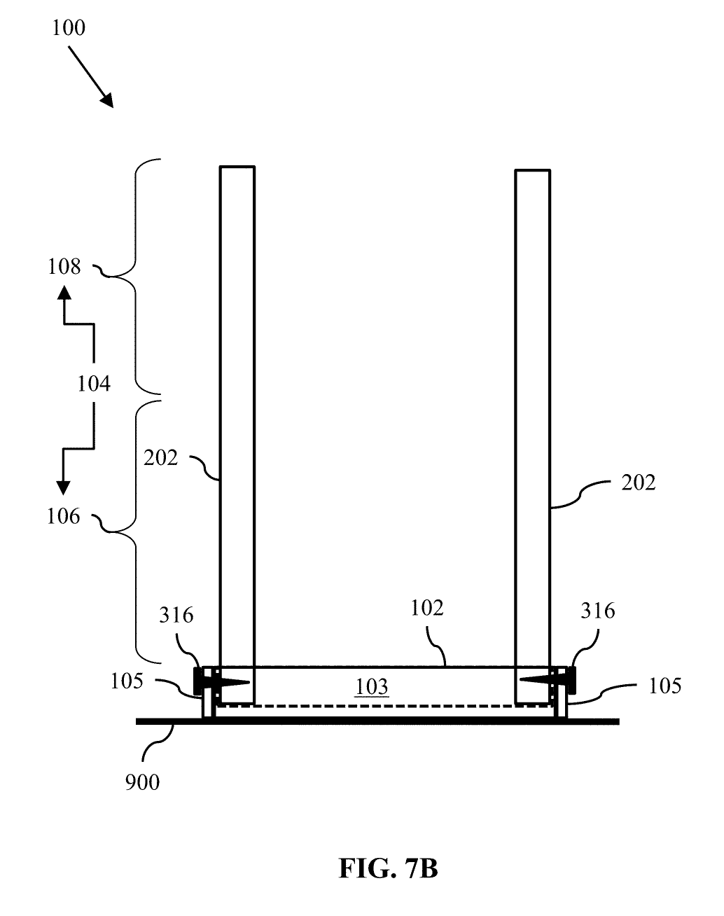

FIG. 7A depicts a front view of an embodiment of the waterfall system 100 of FIG. 1.

Referring to the embodiment as depicted in FIG. 7A, the spaced-apart elongated columns 202 are affixed (either directly or indirectly) to the container assembly 102 using suitable connectors.

FIG. 7B depicts a front view of an embodiment of the waterfall system 100 of FIG. 1.

Referring to the embodiment as depicted in FIG. 7B, the end portions of the lower frame section 106 (or the spaced-apart elongated columns 202) are received, at least in part, in the container cavity 103 of the container assembly 102. The lower frame section 106 (or the spaced-apart elongated columns 202) is configured to the fixedly attached to the side walls (end walls) of the container assembly 102, preferably by a connector 316. The end portions of the lower frame section 106 (to be received in the container cavity 103 of the container assembly 102) may be water proofed.

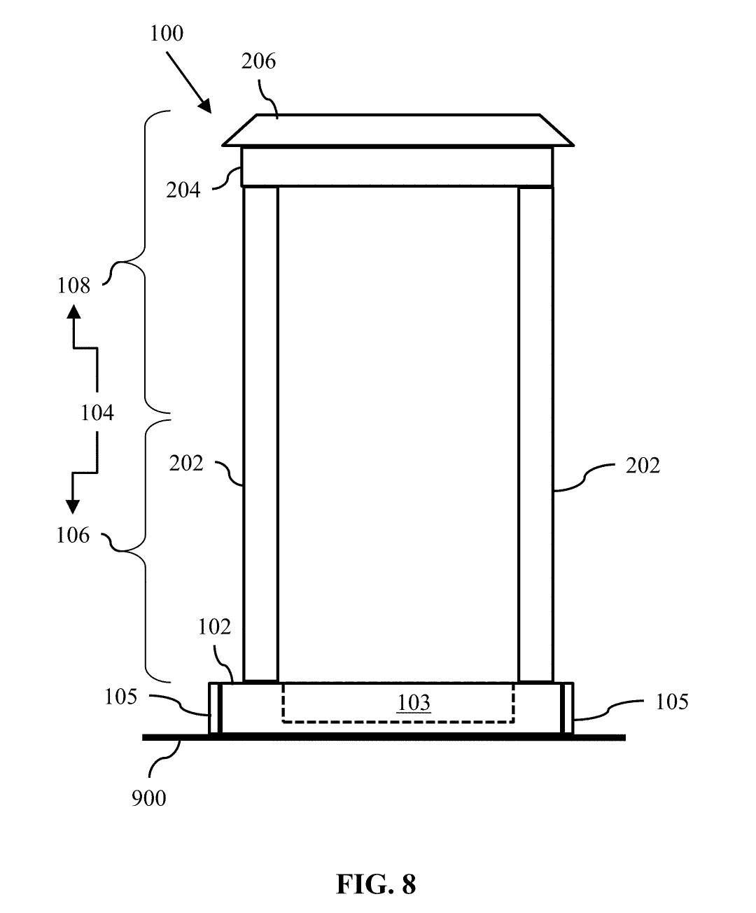

FIG. 8 depicts a front view of an embodiment of the waterfall system 100 of FIG. 1.

Referring to the embodiment as depicted in FIG. 8, a cover assembly 206 is configured to be affixed (either directly or indirectly) to the top section of the frame assembly 104. Preferably, the cover assembly 206 is configured to be affixed (either directly or indirectly) to the top section of the spanning assembly 204.

FIG. 9 and FIG. 10 depict a front view (FIG. 9) and a bottom view (FIG. 10) of embodiments of the waterfall system 100 of FIG. 1.

Referring to the embodiment as depicted in FIG. 9, the spaced-apart water-flow guides 114 are further configured to respectively extend (directly or indirectly) from the tube portion 111 of the tube assembly 110 into the water positioned in the container assembly 102.

The tube assembly 110 is also configured to provide an entrance portal 116 configured to be positioned in the interior of the container assembly 102. Preferably, the pump assembly 112 is fluidly connected to the entrance portal 116, and the pump assembly 112 extends the fluid connection of the entrance portal 116 to the interior of the container assembly 102. The tube assembly 110 is also configured to provide spaced-apart exit portals 118. Generally, the spaced-apart exit portals 118 are spatially positioned (and preferably aligned) along a length of the upper frame section 108 of the frame assembly 104. Preferably, the pump assembly 112 includes a power plug 117 configured to be electrically connected to a power receptacle.

The pump assembly 112 is configured to be positioned relative to (such as, in the interior of) the container assembly 102 (preferably, in such a way that the pump assembly 112 is immersed in water once the container assembly 102, in use, receives water). The pump assembly 112 is also configured to be fluidly connected (either directly or indirectly) to the tube assembly 110, and is also configured to pump water along the tube assembly 110.

The spaced-apart water-flow guides 114 are also configured to respectively extend from the spaced-apart exit portals 118 of the tube assembly 110 toward the water positioned in the interior of the container assembly 102. Preferably, the spaced-apart exit portals 118 are provided by or mounted to the tube portion 111. The spaced-apart water-flow guides 114 are also configured to respectively guide falling flows of the water from the upper frame section 108 of the frame assembly 104, along the spaced-apart water-flow guides 114 and into the interior of the container assembly 102 (once the water is received in, and supported by, the container assembly 102, and once the pump is actuated to pump the water from the container assembly 102, into the entrance portal 116, along the tube assembly 110 and to the spaced-apart exit portals 118 positioned at the upper frame section 108 of the frame assembly 104).

In accordance with an embodiment, the tube assembly 110 is also configured to provide the entrance portal 116 configured to be positioned in the interior of the container assembly 102. The tube assembly 110 is also configured to provide the spaced-apart exit portals 118. The spaced-apart exit portals 118 are spatially positioned (and preferably aligned) along a length of the spanning assembly 204. The spaced-apart water-flow guides 114 are also configured to respectively extend from the spaced-apart exit portals 118 of the tube assembly 110 toward the water positioned in the interior of the container assembly 102. The spaced-apart water-flow guides 114 are also configured to respectively guide falling flows of the water from the spanning assembly 204, along the spaced-apart water-flow guides 114 and into the interior of the container assembly 102 once the water is received in, and supported by, the container assembly 102, and once the pump is actuated to pump the water from the container assembly 102, into the entrance portal 116, along the tube assembly 110 and to the spaced-apart exit portals 118 positioned at the spanning assembly 204.

In accordance with an embodiment, the tube assembly 110 is configured to extend from the interior of the container assembly 102 to the spanning assembly 204 once: (A) the spaced-apart elongated columns 202 are fixedly mounted to, and extend vertically upward from, the container assembly 102, and (B) the spanning assembly 204 is fixedly attached to, and extends between, the spaced-apart elongated columns 202 at a fixed position located vertically above the container assembly 102.

In accordance with an embodiment, the tube assembly 110 is configured to extend from the interior of the container assembly 102, along at least one of the spaced-apart elongated columns 202 to the spanning assembly 204. Preferably, the tube assembly 110 is configured to extend from the interior of the container assembly 102, along the interior of at least one of the spaced-apart elongated columns 202 to the spanning assembly 204.

In accordance with an embodiment, the spaced-apart water-flow guides 114 are also configured to respectively extend from the tube portion 111 of the tube assembly 110 toward the water positioned in the container assembly 102. The tube portion 111 is mounted to the spanning assembly 204, and the spanning assembly 204 is located at the upper frame section 108 of the frame assembly 104. The spaced-apart water-flow guides 114 are also configured to respectively guide falling flows of the water from the spanning assembly 204 into the container assembly 102 once the pump assembly 112, in use, pumps the water along the tube assembly 110.

In accordance with an embodiment, the spanning assembly 204 is configured to be fixedly attached to, and extend between, the spaced-apart elongated columns 202 (once the spaced-apart elongated columns 202 are fixedly mounted to the container assembly 102 and extend vertically upward from the container assembly 102). The spanning assembly 204 is also configured to be fixedly positioned vertically above the container assembly 102.

Preferably, the spanning assembly 204 has a square-shaped cross-sectional profile, and may be made of any suitable material, such as wood, plastic material, steel, copper, metal, etc.

Referring to the embodiment as depicted in FIG. 9, a weight assembly 113 is configured to be connected (either directly or indirectly) to the spaced-apart water-flow guides 114 (such as to the end portion of the spaced-apart water-flow guides 114). The weight assembly 113 may include a pipe portion. The weight assembly 113 is configured to maintain the spaced-apart water-flow guides 114 in a vertically straight alignment. The weight assembly 113 may be called a spacer element or any equivalent thereof.

In accordance with another major aspect, the waterfall system 100 includes (and is not limited to) a synergistic combination of (comprising) a container assembly 102, spaced-apart elongated columns 202, a spanning assembly 204, a tube assembly 110, a pump assembly 112, and spaced-apart water-flow guides 114.

The container assembly 102 is configured to receive and support water. The spaced-apart elongated columns 202 are configured to be mounted to, and extend vertically upward from, the container assembly 102. The spanning assembly 204 is configured to be fixedly attached to, and extend between, the spaced-apart elongated columns 202. The spanning assembly 204 is also configured to be fixedly positioned vertically above the container assembly 102 (once the spanning assembly 204 is fixedly attached to, and is extended between, the spaced-apart elongated columns 202). The tube assembly 110 is configured to extend from the interior of the container assembly 102 to the spanning assembly 204. The pump assembly 112 is configured to be fluidly connected (either directly or indirectly) to the tube assembly 110. The pump assembly 112 is also configured to pump water along the tube assembly 110 (once the pump assembly 112 is fluidly connected to the tube assembly 110).

The spaced-apart water-flow guides 114 are configured to respectively extend from a tube portion 111 of the tube assembly 110 toward the water positioned in the container assembly 102 (in which the tube portion 111 is mounted to, and is supported by, the spanning assembly 204). This is done in such a way that the spaced-apart water-flow guides 114, in use, respectively guide spaced-apart linear flows of water from the tube portion 111 into the container assembly 102 (in which the tube portion 111 is positioned at the spanning assembly 204). This may be done once the pump assembly 112, in use, pumps the water along the tube assembly 110. Advantageously, the spaced-apart water-flow guides 114, in use, minimize the splash of water as the spaced-apart linear flows of water (which are guided along the spaced-apart water-flow guides 114 and which exit from the spanning assembly 204) reach the water contained in the container assembly 102. In addition, the spaced-apart water-flow guides 114, in use, reduce the need to refill the container assembly 102 with additional water since water splash is minimized.

Referring to the embodiment as depicted in FIGS. 9 and 10, the spaced-apart exit portals 118 extend from the bottom section of the spanning assembly 204, and face the container assembly 102.

FIG. 11 and FIG. 12 depict a front view (FIG. 11) and a side view (FIG. 12) of embodiments of the waterfall system 100 of FIG. 1.

Referring to the embodiment as depicted in FIG. 11, the frame assembly 104 is further configured to support a light-source assembly 115 (such as a strip of LED lights, etc., gardening lights, and any equivalent thereof). Preferably, the light-source assembly 115 includes a power plug 117 configured to be electrically connected to a mains receptacle outlet, such as 120 Volts AC (Alternating Current), having a suitable electrical grounding connection (for safety reasons). Alternatively, the light-source assembly 115 is configured to be powered with a solar panel 318 with a back-up battery (if desired). The solar panel 318 may be mounted to the cover assembly 206 (if so desired).

Referring to the embodiment as depicted in FIG. 12, the light-source assembly 115 is mounted to the outer wall of the spanning assembly 204, such as the back wall. Alternatively, the light-source assembly 115 may be positioned at the bottom portion of the spanning assembly 204 (if so desired), to further enhance the light reflecting from the spaced-apart water-flow guides 114.

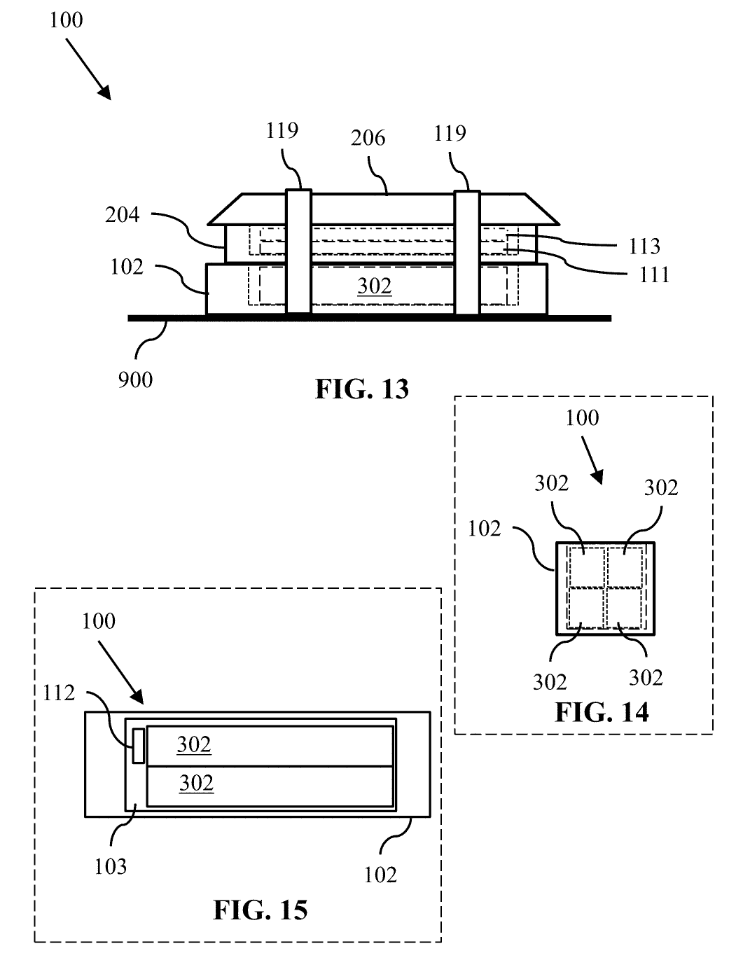

FIG. 13, FIG. 14 and FIG. 15 depict a front view (FIG. 13), an end view (FIG. 14), and a top view (FIG. 15) of embodiments of the waterfall system 100 of FIG. 1.

Referring to the embodiment as depicted in FIG. 13, the detachable columns 302 are configured to be received in the container cavity 103 of the container assembly 102. The spanning assembly 204 is configured to receive the tube portion 111 and the weight assembly 113. The spanning assembly 204 is positioned on the container assembly 102. The cover assembly 206 is positioned on the spanning assembly 204. Strapping 119 (bands) are configured to secure the container assembly 102 with the spanning assembly 204 and the cover assembly 206 in such a way that the components of the waterfall system 100 may be shipped as a single bundle.

Referring to the embodiment as depicted in FIG. 14, the detachable columns 302 are positioned and received in the container cavity 103 of the container assembly 102.

Referring to the embodiment as depicted in FIG. 15, the detachable columns 302 are positioned and received in the container cavity 103 of the container assembly 102. In addition, the pump assembly 112 is received in the container cavity 103 of the container assembly 102.

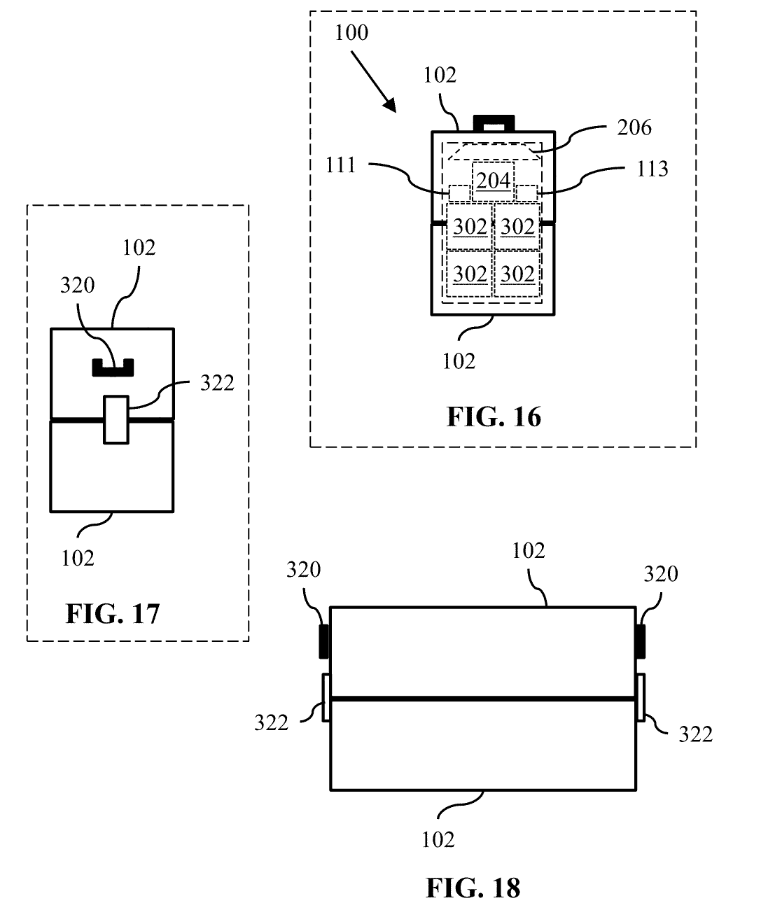

FIG. 16, FIG. 17 and FIG. 18 depict a side view (FIG. 16), an end view (FIG. 17), and a front view (FIG. 18) of embodiments of the waterfall system 100 of FIG. 1.

FIG. 16 depicts the waterfall system 100 in a knocked down condition, in which the waterfall system 100 includes two instances (duplicates) of the container assembly 102 (or any equivalent thereof). The container assemblies 102 are placed an open-end to open-end relationship. This is done in such a way that the interior space formed by the two instances of the container assemblies 102 may receive the remaining components of the waterfall system 100 (for convenient storage and transport purposes).

FIG. 17 and FIG. 18 depict a handle 320, in which instances of the handle 320 are positioned on the end faces of the container assembly 102. This arrangement allows the components of the waterfall system 100, in the knocked down condition, to be received and stored in the oppositely facing container assembles 102, which then may be picked up by the user (or users) by the handles 320. A connector 322 is configured to securely attach the container assemblies 102 together (in an open-end to open-end relationship relative to each other). The connectors 322 are configured to securely connect the end faces of the container assemblies 102 together.

It is understood that each claim in the claims section is an open ended claim unless stated otherwise. Unless otherwise specified, relational terms used in the specifications should be construed to include certain tolerances that the person skilled in the art would recognize as providing equivalent functionality. By way of example, the term perpendicular is not necessarily limited to 90.0 degrees, and may include a variation thereof that the person skilled in the art would recognize as providing equivalent functionality for the purposes described for the relevant member or element. Terms such as “about” and “substantially”, in the context of configuration, relate generally to disposition, location, or configuration that are either exact or sufficiently close to the location, disposition, or configuration of the relevant element to preserve operability of the element within the invention which does not materially modify the invention. Similarly, unless specifically made clear from its context, numerical values should be construed to include certain tolerances that the person skilled in the art would recognize as having negligible importance as they do not materially change the operability of the invention. It will be appreciated that the description and/or drawings identify and describe embodiments of the apparatus (either explicitly or inherently). The apparatus may include any suitable combination and/or permutation of the technical features as identified in the detailed description, as may be required and/or desired to suit a particular technical purpose and/or technical function. It will be appreciated that, where possible and suitable, any one or more of the technical features of the apparatus may be combined with any other one or more of the technical features of the apparatus (in any combination and/or permutation). It will be appreciated that persons skilled in the art would know that the technical features of each embodiment may be deployed (where possible) in other embodiments even if not expressly stated as such above. It will be appreciated that persons skilled in the art would know that other options would be possible for the configuration of the components of the apparatus to adjust to manufacturing requirements and still remain within the scope as described in at least one or more of the claims. This written description provides embodiments, including the best mode, and also enables the person skilled in the art to make and use the embodiments. The patentable scope may be defined by the claims. The written description and/or drawings may help to understand the scope of the claims. It is believed that all the crucial aspects of the disclosed subject matter have been provided in this document. It is understood, for this document, that the word “includes” is equivalent to the word “comprising” in that both words are used to signify an open-ended listing of assemblies, components, parts, etc. The term “comprising”, which is synonymous with the terms “including,” “containing,” or “characterized by,” is inclusive or open-ended and does not exclude additional, unrecited elements or method steps. Comprising (comprised of) is an “open” phrase and allows coverage of technologies that employ additional, unrecited elements. When used in a claim, the word “comprising” is the transitory verb (transitional term) that separates the preamble of the claim from the technical features of the invention. The foregoing has outlined the non-limiting embodiments (examples). The description is made for particular non-limiting embodiments (examples). It is understood that the non-limiting embodiments are merely illustrative as examples.

What is claimed is:

1. An apparatus, comprising:
a waterfall system, including:
a container assembly configured to be positioned on a working surface, and the container assembly is also configured to receive and support water therein once the container assembly is positioned on the working surface; and
a frame assembly configured to be fixedly mounted to, and to extend vertically upward from, the container assembly, and the frame assembly having a vertical height extending, at least in part, from a lower frame section of the frame assembly to an upper frame section of the frame assembly once the frame assembly is fixedly mounted to, and extends vertically upward from, the container assembly; and
the frame assembly also configured to accommodate a tube assembly, in which the tube assembly is configured to extend from the interior of the container assembly, along, at least in part, the vertical height of the frame assembly from the lower frame section toward the upper frame section of the frame assembly once the frame assembly is fixedly mounted to, and is extended vertically upward from, the container assembly, and in which the tube assembly is also configured to be fluidly connected to a pump assembly, in which the pump assembly is configured to pump water along the tube assembly once the pump assembly is fluidly connected to the tube assembly; and
spaced-apart water-flow guides configured to respectively extend from a tube portion of the tube assembly, in which the tube portion is mounted to the upper frame section of the frame assembly, toward the water positioned in the container assembly in such a way that the spaced-apart water-flow guides, in use, respectively guide spaced-apart linear flows of water from the tube portion positioned at the upper frame section of the frame assembly into the container assembly once the pump assembly, in use, pumps the water along the tube assembly.

2. The apparatus of claim 1, wherein:
the spaced-apart water-flow guides are further configured to respectively extend from the tube portion of the tube assembly into the water positioned in the container assembly; and
the spaced-apart water-flow guides are further configured to provide a spacing of air between the spaced-apart water-flow guides once the water is made to run along the spaced-apart water-flow guides toward the container assembly in such a way that the spaced-apart water-flow guides, in use, permit a partially obstructed view of a scenery that is located or positioned behind the spaced-apart water-flow guides.

3. The apparatus of claim 1, wherein:
the tube assembly is also configured to provide an entrance portal configured to be positioned in the interior of the container assembly; and
the tube assembly is also configured to provide spaced-apart exit portals, and the spaced-apart exit portals are spatially positioned along a length of the upper frame section of the frame assembly.

4. The apparatus of claim 3, wherein:
the pump assembly is configured to be positioned relative to the container assembly, and the pump assembly is also configured to be fluidly connected to the tube assembly, and is also configured to pump water along the tube assembly.

5. The apparatus of claim 4, wherein:
the spaced-apart water-flow guides are also configured to:
respectively extend from the spaced-apart exit portals of the tube assembly toward the water positioned in the interior of the container assembly; and
respectively guide falling flows of the water from the upper frame section of the frame assembly, along the spaced-apart water-flow guides and into the interior of the container assembly once the water is received in, and supported by, the container assembly, and once the pump is actuated to pump the water from the container assembly, into the entrance portal, along the tube assembly and to the spaced-apart exit portals positioned at the upper frame section of the frame assembly.

6. The apparatus of claim 1, wherein:
the spaced-apart water-flow guides are elongated and linear.

7. The apparatus of claim 1, wherein:
the spaced-apart water-flow guides include:
a set of guide wires.

8. The apparatus of claim 1, wherein:
the frame assembly includes:
spaced-apart elongated columns configured to be fixedly mounted to, and to extend vertically upward from, the container assembly in such a way that once the spaced-apart elongated columns are fixedly mounted to the container assembly, the spaced-apart elongated columns extend vertically upward from the container assembly.

9. The apparatus of claim 8, wherein:
at least one of the spaced-apart elongated columns has a square-shaped cross-sectional profile.

10. The apparatus of claim 8, wherein:
each of the spaced-apart elongated columns are configured to be formed from detachable columns.

11. The apparatus of claim 10, wherein:
the detachable columns are configured to be fixedly connected with each other in an end-to-end relationship.

12. The apparatus of claim 8, wherein:
the frame assembly further includes:
a spanning assembly configured to be fixedly attached to, and to extend between, the spaced-apart elongated columns, and also configured to be fixedly positioned vertically above the container assembly.

13. The apparatus of claim 12 wherein:
the tube assembly is also configured to provide an entrance portal configured to be positioned in the interior of the container assembly; and
the tube assembly is also configured to provide spaced-apart exit portals, and the spaced-apart exit portals are spatially positioned along a length of the spanning assembly; and
the spaced-apart water-flow guides are also configured to:
respectively extend from the spaced-apart exit portals of the tube assembly toward the water positioned in the interior of the container assembly; and
respectively guide falling flows of the water from the spanning assembly, along the spaced-apart water-flow guides and into the interior of the container assembly once the water is received in, and supported by, the container assembly, and once the pump is actuated to pump the water from the container assembly, into the entrance portal, along the tube assembly and to the spaced-apart exit portals positioned at the spanning assembly.

14. The apparatus of claim 12, wherein:
the tube assembly is configured to extend from the interior of the container assembly to the spanning assembly once:
the spaced-apart elongated columns are fixedly mounted to, and extend vertically upward from, the container assembly; and
the spanning assembly is fixedly attached to, and extends between, the spaced-apart elongated columns at a fixed position located vertically above the container assembly.

15. The apparatus of claim 12, wherein:
the tube assembly is configured to extend from the interior of the container assembly, along at least one of the spaced-apart elongated columns to the spanning assembly.

16. The apparatus of claim 12, wherein:
the tube assembly is configured to extend from the interior of the container assembly, along the interior of at least one of the spaced-apart elongated columns to the spanning assembly.

17. The apparatus of claim 12, wherein:
the spaced-apart water-flow guides are configured to:
respectively extend from the tube portion of the tube assembly, in which the tube portion is mounted to the spanning assembly, in which the spanning assembly is located at the upper frame section of the frame assembly, toward the water positioned in the container assembly; and
respectively guide falling flows of the water from the spanning assembly into the container assembly once the pump assembly, in use, pumps the water along the tube assembly.

18. The apparatus of claim 12, wherein:
the spanning assembly is configured to be fixedly attached to, and extend between, the spaced-apart elongated columns once the spaced-apart elongated columns are fixedly mounted to the container assembly and extend vertically upward from the container assembly, and
the spanning assembly is also configured to be fixedly positioned vertically above the container assembly.

19. The apparatus of claim 12, wherein:
the spanning assembly has a square-shaped cross-sectional profile.

20. An apparatus, comprising:
a waterfall system, including:
a container assembly configured to receive and support water; and
spaced-apart elongated columns configured to be mounted to, and to extend vertically upward from, the container assembly; and
a spanning assembly configured to be fixedly attached to, and to extend between, the spaced-apart elongated columns, and the spanning assembly also configured to be fixedly positioned vertically above the container assembly once the spanning assembly is fixedly attached to, and is extended between, the spaced-apart elongated columns; and
a tube assembly configured to extend from the interior of the container assembly to the spanning assembly; and
a pump assembly configured to be fluidly connected to the tube assembly, and the pump assembly also configured to pump water along the tube assembly once the pump assembly is fluidly connected to the tube assembly; and
spaced-apart water-flow guides configured to respectively extend from a tube portion of the tube assembly, in which the tube portion is mounted to the spanning assembly, toward the water positioned in the container assembly in such a way that the spaced-apart water-flow guides, in use, respectively guide spaced-apart linear flows of water from the tube portion, in which the tube portion is positioned at the spanning assembly, into the container assembly once the pump assembly, in use, pumps the water along the tube assembly.
